(19) United States
(12) Patent Application Publication
(10) Pub. No.: US 2007/0266981 A1
(43) Pub. Date: Nov. 22, 2007

(54) Control Apparatus and Control Method of Internal Combustion Engine

(75) Inventors: Nao Murase, Shizuoka-ken (JP); Hiroki Ichinose, Shizuoka-ken (JP); Yuuichi Katou, Shizuoka-ken (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi-ken (JP)

(21) Appl. No.: 11/793,469

(22) PCT Filed: Jan. 13, 2006
(86) PCT No.: PCT/JP06/00781

§ 371 Date: Jun. 20, 2007

(30) Foreign Application Priority Data
Jan. 13, 2005 (JP) 2005-006455

(51) Int. Cl. F02D 13/00

(52) U.S. Cl. 123/179.5

(57) ABSTRACT

Provided is a control apparatus and a control method of an internal combustion engine which can intend to suppress a deterioration of an emission and suppress a reduction of a startability. According to the method, a target ignition timing at a time of starting an internal combustion engine is acquired (step ST101); an ignition timing is controlled to a spark advance side and an air fuel ratio of the internal combustion engine is controlled to a lean side (step ST103) if a start of a cranking is judged (step ST102); the ignition timing is controlled to a spark retard side (step ST106) if an end of a first cycle after the cranking is judged based on the acquired engine speed (steps ST104 and ST105); and a spark advance correction of the ignition timing to a spark advance direction in correspondence to an exhaust temperature is executed until the ignition timing comes to the target ignition timing (steps ST108, ST109, and ST110).

### TECHNICAL FIELD

The present invention relates to a control apparatus and a control method of an internal combustion engine, and more particularly to a control apparatus and a control method which control at least an ignition timing of an ignition unit at a time of starting an internal combustion engine by a starting unit.

### BACKGROUND ART

In general, an internal combustion engine such as a gasoline engine, a diesel engine and the like mounted on a vehicle such as a passenger vehicle, a truck or the like is provided with a starter corresponding to a starting unit. At a time of starting the internal combustion engine, there is executed a cranking for rotating a crank shaft of the internal combustion engine up to a fixed rotational speed by the starter. Further, the cranking is executed by the starter, and a mixed gas within each of cylinders is exploded and burned in a state in which the crank shaft of the internal combustion engine is rotated at a fixed degree, whereby a rotating force (a rotating torque) is applied to the crank shaft, and the internal combustion engine is started.

When the internal combustion engine starts, a lot of harmful materials, particularly, Hydrocarbon (HC) is contained in an exhaust gas discharged to an exhaust path from a combustion chamber. In this case, a purifying apparatus for oxidizing the HC is provided in the exhaust path of the internal combustion engine. Accordingly, the exhaust gas passes through the purifying apparatus, whereby the HC in the exhaust gas is oxidized, that is, the exhaust gas is processed, so that it is possible to reduce an amount of the HC exhausted to the atmosphere from the exhaust path. However, when the internal combustion engine starts, particularly starts under a cold state, a temperature of the purifying apparatus is not increased. Since a purifying catalyst of the purifying apparatus is activated in correspondence to an increase of the temperature, it is not possible to obtain a sufficient processing capacity. In other words, when the internal combustion engine starts, a lot of HC are exhausted to the atmosphere from the exhaust path, and there is a risk that an emission is deteriorated.

Accordingly, in the conventional internal combustion engine, there has been proposed a technique of reducing the amount of the HC exhausted to the atmosphere from the exhaust path so as to suppress the deterioration of the emission by setting an ignition timing of an ignition plug serving as the ignition unit to a widely spark retard side with respect to a normal ignition timing at a time of starting the internal combustion engine, at a time of starting the internal combustion engine. For example, in a conventional control apparatus of an internal combustion engine shown in Japanese Patent Application Laid-Open No. H8-232745, a catalyst activation is intended by executing a retard control (a spark retard control) of the ignition timing of the ignition plug until a predetermined time passes from the start, and a suppression of HC amount and CO amount is intended by executing an air fuel ratio control so that an air fuel ratio becomes in a lean side, in a period until a temperature of a cooling water thereafter ascends to a predetermined temperature (a warm-up operation of the internal combustion engine).

### DISCLOSURE OF INVENTION

However, in the conventional internal combustion engine as shown in Japanese Patent Application Laid-Open No. H8-232745, just after the cranking, that is, if any one of the cylinders is first exploded, the engine speed ascends more than the engine speed caused by the cranking, however, if a cycle number of each of the cylinders makes progress, the engine speed goes on descending, so that it is impossible to rotate the crank shaft by the rotating force generated by the explosive combustion of the mixed gas, and there is a risk that the internal combustion engine stops. In other words, there is a risk that a startability of the internal combustion engine is lowered. This is because a throttle valve in an intake air path is approximately closed at a time of starting the internal combustion engine, that is, a throttle reduction is executed, an amount of the intake air sucked into each of the cylinders from the intake air path becomes small, and a charging efficiency within the cylinder is lowered. In other words, if the ignition timing of the ignition plug is controlled in a spark retard manner at a time of starting the internal combustion engine, the rotating force applied to the crank shaft becomes small, and the engine speed is lowered. In this case, the engine speed ascends just after the cranking because the air at a volumetric capacity from the throttle valve to each of the cylinders is sucked into the cylinder just after the cranking, whereby the charging efficiency within the cylinder ascends.

The present invention has been achieved in order to solve the above problems. It is an object of this invention to provide a control apparatus and a control method of an internal combustion engine that can intend to suppress a deterioration of an emission and suppress a reduction of a startability.

In order to solve the above problem and achieve the object, a control apparatus of an internal combustion engine according to one aspect of the invention includes an ignition timing control unit controlling an ignition timing of an ignition unit at a time of starting the internal combustion engine by a starting unit, wherein the ignition timing is set to a spark advance side with respect to a target ignition timing at a time of starting the internal combustion engine until a predetermined cycle after a cranking by the starting unit, and is set to a spark retard side with respect to the target ignition timing after the predetermined cycle.

In the control apparatus of the internal combustion engine according to the invention, the predetermined cycle may correspond to the first cycle after the cranking by the starting unit.

A control method according to another aspect of the invention is of an internal combustion engine for controlling an ignition timing of an ignition unit at a time of starting the internal combustion engine by a starting unit, the method including setting an ignition timing to a spark advance side with respect to a target ignition timing at a time of starting the internal combustion engine until a predetermined cycle after a cranking by the starting unit; and setting the ignition timing to a spark retard side with respect to the target ignition timing after the predetermined cycle.

According to these inventions, the ignition timing of the ignition unit in each of the cylinders is set to the spark advance side with respect to the target ignition timing until the predetermined cycle after the cranking. In other words, an engine speed just after the cranking widely ascends in comparison with a case where the ignition timing mat be controlled in the spark retard manner after the cranking such as the conventional control apparatus of the internal combustion engine. Accordingly, even if the engine speed descends in accordance that the cycle number in each of the cylinders of the internal combustion engine is increased by setting the ignition timing to the spark retard side with respect to the target ignition timing after the predetermined cycle, the engine speed at a time when the engine speed starts descending is high, so that it is possible to inhibit the engine speed in an optional cycle number after the cranking from descending. In other words, it is possible to increase the cycle number until the engine speed becomes an engine speed which can not maintain the rotation of the crank shaft by the rotating force applied to the crank shaft from each of the cylinders, after the cranking.

Further, since the combustion temperature is low until the predetermined cycle after the cranking, an amount of HC contained in the exhaust gas exhausted to the exhaust path is hardly changed even by changing the ignition timing. Accordingly, even if the ignition timing is set to the spark advance side with respect to the target ignition timing, the amount of the HC exhausted to the atmosphere from the exhaust path is not increased until the predetermined cycle after the cranking.

Further, it is possible to ascends the exhaust temperature of the exhaust gas exhausted to the exhaust path at an early timing after the cranking, by setting the ignition timing to the spark retard side with respect to the target ignition timing after the predetermined cycle, and it is possible to activate the purifying catalyst oxidizing the HC at an early timing. Accordingly, it is possible to reduce the amount of the HC exhausted to the atmosphere from the exhaust path based on the activation of the purifying catalyst.

In the control apparatus of the internal combustion engine according to the invention, the ignition timing set to the spark retard side of the target ignition timing may be corrected to the spark advance side repeatedly until the ignition timing comes to the target ignition timing.

The control apparatus of the internal combustion engine according to the invention may further include an exhaust temperature detecting unit detecting an exhaust temperature of an exhaust gas exhausted from the internal combustion engine, wherein the spark advance correction is set to an ignition timing at which the oxidation of the HC contained in the exhaust gas is promoted in correspondence to the detected exhaust temperature.

According to the inventions, the ignition timing set to the spark retard side of the target ignition timing is not maintained constant, but the ignition timing is repeatedly corrected to the spark advance side, for example, within the HC oxidation promoting region in which the oxidation of the HC is promoted. In other words, the spark advance correction of correcting the ignition timing to the spark advance side is repeated while maintaining the ascent of the exhaust temperature of the exhaust gas exhausted to the exhaust path in connection with the increase of the cycle number after the predetermined cycle. Accordingly, the ignition timing comes close to the target ignition timing in connection with the increase of the cycle number after the predetermined cycle. Therefore, it is possible to suppress the reduction of the engine speed in connection with the increase of the cycle number after the predetermined cycle while maintaining the activation of the purifying apparatus.

The control apparatus of the internal combustion engine according to the invention may further include an air fuel ratio control unit for controlling an air fuel ratio of the internal combustion engine at a time of starting the internal combustion engine by the starting unit, wherein the air fuel ratio is set to a lean side until the start of the internal combustion engine is finished after the cranking by the starting unit.

According to the invention, the air fuel ratio control unit sets the air fuel ratio of the engine until the start of the internal combustion engine is finished after the cranking at least to the lean side, and increases an amount of oxygen contained in the exhaust gas exhausted to the exhaust path. Accordingly, it is possible to easily oxidize the HC contained in the exhaust gas by the purifying apparatus. Accordingly, it is possible to further reduce the amount of the HC exhausted to the atmosphere from the exhaust path.

Alternatively, since the range of the HC oxidation promoting region is widened by increasing the amount of the oxygen contained in the exhaust gas exhausted to the exhaust path, it is possible to set the ignition timing to further the spark advance side in the spark advance correction. Accordingly, it is possible to further suppress the reduction of the engine speed in connection with the increase of the cycle number after the predetermined cycle.

The control apparatus of the internal combustion engine according to the invention may further include a fuel supply amount control unit for controlling a supply amount of a fuel supplied to the internal combustion engine, and an intake air amount control unit controlling an amount of intake air sucked to the internal combustion engine, wherein the intake air amount and the fuel injection amount are increased at least during a period when the ignition timing is set to the spark retard side from the target ignition timing.

According to the invention, the intake air amount and the fuel injection amount are increased during the period when the ignition timing is set to the spark retard side with respect to the target ignition timing, and the rotating force applied to the crank shaft from each of the cylinders is increased. Therefore, it is possible to further suppress the reduction of the engine speed in connection with the increase of the cycle number after the predetermined cycle.

The control apparatus and the control method of the internal combustion engine according to the invention can intend to suppress a deterioration of an emission and suppress the reduction of the startability.

### BRIEF DESCRIPTION OF DRAWINGS

FIG. 1 is a view showing a configuration example of an internal combustion engine according to a first embodiment;

FIG. 2 is a flowchart showing an operation flow of a control apparatus of the internal combustion engine according to the first embodiment;

FIG. 3A is a graph showing a relation between cycle number and engine speed;

FIG. 3B is a graph showing a relation between cycle number and engine speed;

FIG. 3C is a graph showing a relation between cycle number and exhaust temperature;

FIG. 4 is a graph showing an example of an ignition timing map;

FIG. 5 is a flowchart showing an operation flow of a control apparatus of an internal combustion engine according to a second embodiment;

FIG. 6A is a graph showing a relation between cycle number and engine speed;

FIG. 6B is a graph showing a relation between cycle number and intake air amount;

FIG. 6C is a graph showing a relation between cycle number and fuel supply amount; and

FIG. 6D is a graph showing a relation between cycle number and air fuel ratio.

### BEST MODE(S) FOR CARRYING OUT THE INVENTION

Hereinafter, the invention is described in detail with reference to the accompanying drawings. In this case, the invention is not limited by the following embodiments. Further, constituting elements in the following embodiments include structures which those skilled in the art can easily derive or substantially the same structures.

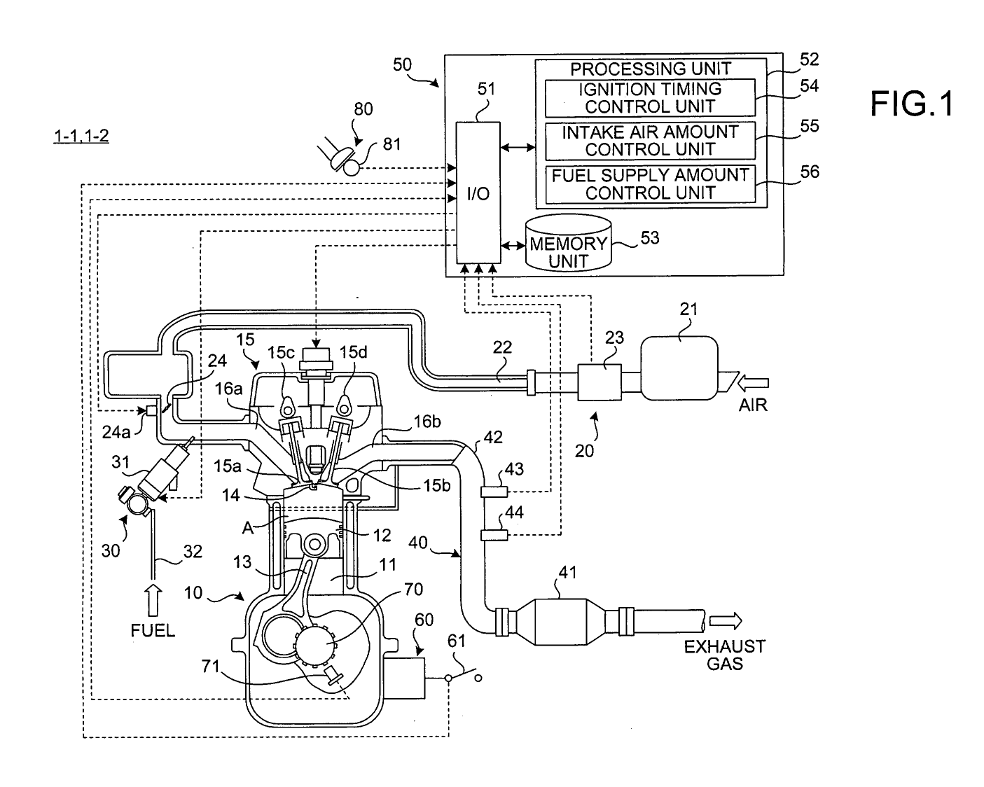

FIG. 1 is a view showing a configuration example of an internal combustion engine according to a first embodiment. As shown in the drawing, an internal combustion engine 1-1 according to the invention is constituted by an internal combustion engine main body 10 such as a gasoline engine or the like, an intake air path 20, a fuel supply apparatus 30, an exhaust path 40, an engine control unit (ECU) 50 executing an operation control of the internal combustion engine 1, and a starter 60. In this case, the reference numeral 70 denotes a crank shaft, and the reference numeral 71 denotes a crank angle sensor detecting an engine speed of the internal combustion engine 1-1 and a cycle number of each of cylinders 11 based on a crank angle of the crank shaft so as to output to the ECU 50 mentioned below. Further, the reference numeral 80 denotes an accelerator pedal, and the reference numeral 81 denotes an accelerator pedal sensor detecting an accelerator opening degree of the accelerator pedal 80 so as to output to the ECU 50 mentioned below.

An intake air path 20 is connected to the internal combustion engine main body 10, and an air and a fuel are introduced to each of the cylinders 11 of the internal combustion engine main body 10 from an external portion via the intake air path 20. Further, an exhaust-path 40 is connected to the internal combustion engine main body 10, and the exhaust gas exhausted from each of the cylinders 11 of the internal combustion engine main body 10 is exhausted to an external portion via the exhaust path 40. Each of the cylinders 11 of the internal combustion engine main body 10 is constituted by a piston 12, a connecting rod 13, an ignition plug 14 and a valve apparatus 15. In this case, a combustion chamber A is formed in each of the cylinders. Each of the combustion chambers A is connected to an intake air port 16a, and the intake air port 16a is connected to the intake air path 20. Further, the combustion chamber A in each of the cylinders is connected to each of exhaust ports 16b, and the exhaust port 16b is connected to the exhaust path 40.

The piston 12 is rotatably supported to the connecting rod 13. The connecting rod 13 is rotatably supported to one crank shaft 70. In other words, the crank shaft 70 is structured such as to be rotated by a reciprocating motion of the piston 12 within the cylinder 11 based on a combustion of a mixed gas of intake air and a fuel within the combustion chamber A in each of the cylinders.

The valve apparatus 15 is structured such as to open and close each of an intake air valve 15a and an exhaust valve 15b. The valve apparatus 15 is constituted by the intake air valve 15a, the exhaust valve 15b, an intake cam shaft 15c and an exhaust cam shaft 15d. The intake air valve 15a is arranged between the intake air port 16a and the combustion chamber A in each of the cylinders, and is structured such as to repeatedly achieve a communication between the intake air port 15a and the combustion chamber A in each of the cylinders based on a rotation of the intake cam shaft 15c. In other words, the intake air valve 15a is structured such as to achieve a communication between the intake air path 20 and each of the cylinders 11. Further, the exhaust valve 15b is arranged between the combustion chamber A in each of the cylinders and the exhaust port 16b, and is structured such as to repeatedly achieve a communication between the combustion chamber A in each of the cylinders and the exhaust port 16b based on a rotation of the exhaust cam shaft 15d. In other words, the exhaust valve 15d is structured such as to achieve a communication between each of the cylinders 11 and the exhaust path 40.

The intake air path 20 is constituted by an air cleaner 21, an intake air passage 22, an air flow meter 23 and a throttle valve 24. The air from which the dust is removed by the air cleaner 21 is introduced to each of the cylinders 11 of the internal combustion engine main body 10 via the intake air passage 22. The air flow meter 23 is structured such as to detect a intake air amount of the air introduced, that is, sucked into the internal combustion engine main body 10 so as to output to the ECU 50 mentioned below. The throttle valve 24 is structured such as to adjust an amount of the intake air sucked into each of the cylinders 11 of the internal combustion engine main body 10 by being driven by an actuator 24a. A control of an opening degree of the throttle valve 24, that is, a valve opening degree control is executed by the ECU 50 mentioned below.

The fuel supply apparatus 30 is structured such as to supply the fuel to the internal combustion engine 1-1, and is constituted by a fuel injection valve 31, a fuel passage 32, a fuel pump (not shown), and a fuel tank (not shown). The fuel injection valve 31 is provided in the intake air passage 22 of the intake air path 20 communicated with each of the cylinders 11. The fuel reserved in the fuel tank (not shown) is pressure fed to the fuel injection valve 31 via a fuel passage 32 based on the drive of the fuel pump (not shown). A control of a fuel injection amount, an injection timing and the like of the fuel injection valve 31, that is, an injection control is executed by the ECU 50 mentioned below. In this case, the fuel injection valve 31 may be provided within each of the cylinders 11.

The exhaust path 40 is constituted by a purifying apparatus 41 and an exhaust passage 42. The exhaust gas exhausted from the internal combustion engine main body 10 is introduced to the purifying apparatus 41 via the exhaust passage 42, and is exhausted to an external portion after a harmful material is purified by the purifying apparatus 41. The purifying apparatus 41 is structured such as to purify, that is, oxidize an HC in the harmful material contained in the exhaust gas so as to change to a harmless material. In this case, the exhaust passage 42 in an upstream side of the purifying apparatus 41 is provided with an A/F sensor 43 detecting an air fuel ratio of the exhaust gas exhausted to the exhaust passage 42 so as to output to the ECU 50 mentioned below, and an exhaust temperature sensor 44 detecting an exhaust temperature of the exhaust gas exhausted to the exhaust passage 42 so as to output to the ECU 50 mentioned below.

The ECU 50 is corresponds to a control apparatus of the internal combustion engine 1-1 according to the invention, and controls an operation of the internal combustion engine 1-1. Various input signals are input to the ECU 50 from sensors attached to respective positions in a vehicle (not shown) on which the internal combustion engine 1-1 is mounted. In particular, the input signals include an engine speed and a cycle number detected by an angle sensor 71 attached to a crank shaft 70, the intake air amount detected by the air flow meter 23, the air fuel ratio of the internal combustion engine 1-1 based on the air fuel ratio of the exhaust gas detected by the A/F sensor 43, the exhaust temperature of the exhaust gas detected by the exhaust temperature sensor 44 and the like. The ECU 50 outputs various output signals based on the input signals and various maps stored in a memory unit 53. In particular, the output signals include a valve opening signal executing a valve opening control of the throttle valve 24, an injection signal executing an injection control of the fuel injection valve 31, an ignition signal executing an ignition control of the ignition plug 14 and the like.

In particular, the ECU 50 is constituted by an input and output port (an I/O) 51 executing an input and output of the input signal and the output signal, a processing unit 52, and a memory unit 53 storing various maps such as a fuel injection amount map, an ignition timing map and the like. The processing unit 52 has an ignition timing control unit 54 controlling an ignition timing of the ignition plug, an intake air amount control unit 55 controlling an amount of the intake air sucked into the internal combustion engine 1-1 based on the valve opening degree of the throttle valve 24, and a fuel supply amount control unit 56 controlling a supply amount of the fuel supplied to the internal combustion engine 1-1 based on an injection amount of the fuel injected to the intake air path from the fuel injection valve 31. The processing unit 52 may be constituted by a memory and a central processing unit (CPU), and may be structured such as to achieve a control method of the internal combustion engine 1-1 or the like by loading a program based on the control method of the internal combustion engine 1-1 or the like in the memory so as to execute. Further, the memory unit 53 can be constituted by a non-volatile memory such as a flash memory or the like, a volatile memory such as a read only memory (ROM) which can be only read, a volatile memory such as a random access memory (RAM) which can be read and written, of a combination thereof. Further, according to the invention, the control method of the internal combustion engine 1-1 is achieved by the ECU 50, however, is not limited to this, but may be achieved by a control apparatus that is independently formed from the ECU 50.

The starter 60 is a starting unit, and is constituted by a motor or the like. The starter 60 is structured such that a starter switch 61 is turned on by a driver's intention to start the internal combustion engine, whereby the starter is energized so as to be driven. The starter 60 is coupled to a crank shaft 70 and drives the crank shaft 70 so as to rotate to a fixed rotational speed. In other words, the starter 60 is structured such as to rotate the internal combustion engine 1-1 up to a fixed engine speed.

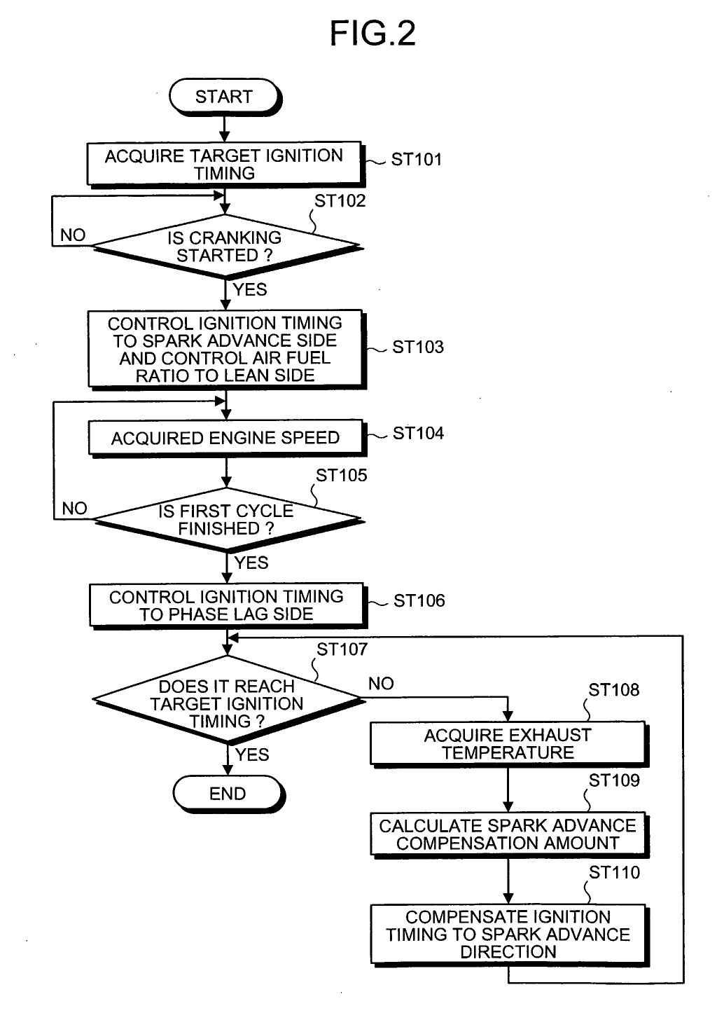

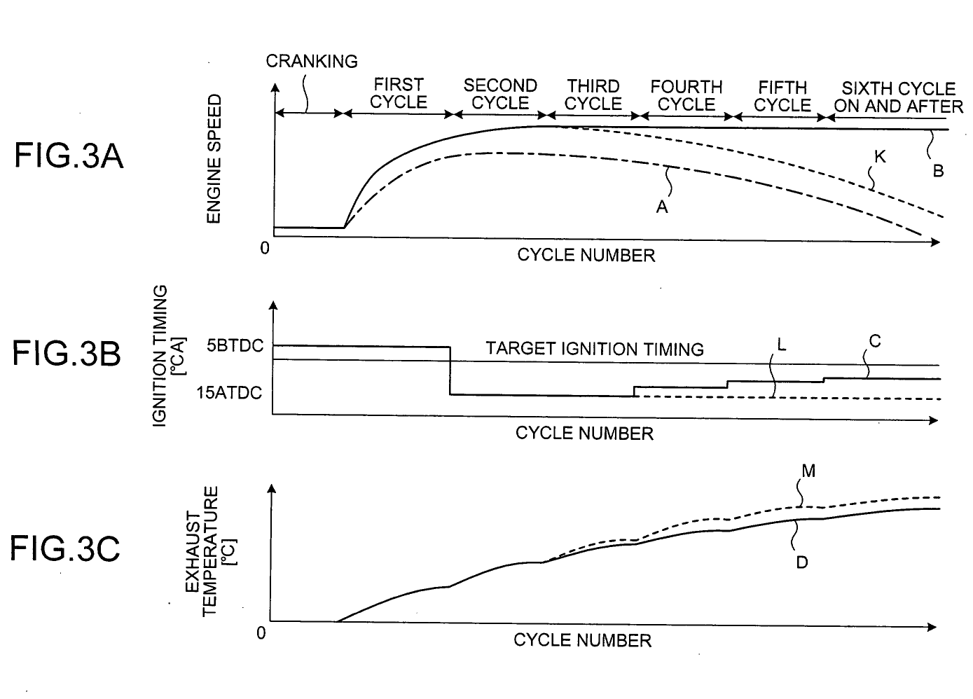

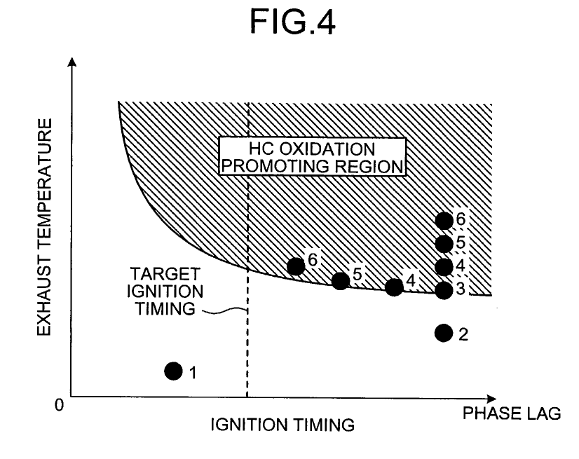

Next, an operation of the ECU 50 corresponding to the control apparatus of the internal combustion engine 1-1 according to the first embodiment will be described. FIG. 2 is a flowchart showing an operation flow of the control apparatus of the internal combustion engine according to the first embodiment. FIG. 3A is a graph showing a relation between cycle number and engine speed; FIG. 3B is a graph showing a relation between cycle number and engine speed; and FIG. 3C is a graph showing a relation between cycle number and exhaust temperature. FIG. 4 is a graph showing an example of the ignition timing map.

First, as shown in FIG. 2, the ignition timing control unit 54 of the processing unit 52 of the ECU 50 acquires a target ignition timing at a time of starting the internal combustion engine 1-1 (step ST101). The target ignition timing is previously set based on the specification of the internal combustion engine 1-1, and is stored in the memory unit 53. In this case, the target ignition timing is constituted, for example, an ignition timing at a time when the operation of the internal combustion engine 1-1 is controlled in an idling state, and the like.

Next, the ignition timing control unit 54 of the processing unit 52 judges whether or not the cranking is started (step ST102). In this case, the starter 60 starts the cranking of the internal combustion engine 1-1 in accordance that the starter switch 61 is turned on. Accordingly, the ignition timing control unit 54 judges the start of the cranking, for example, based on the judgment whether or not the cranking switch 61 is turned on. In this case, the ignition timing control unit 54 of the processing unit 52 repeats the step ST102 if it judges that the cranking is not started.

Next, if the ignition timing control unit 54 of the processing unit 52 judges that the cranking is started, it sets the ignition timing to the spark advance side with respect to the target ignition timing, and executes the spark advance control of the ignition plug. Further, if the ignition timing control unit 54 judges that the cranking is started, the fuel supply amount control unit 56 and the intake air amount control unit 55 of the processing unit 52 set the air fuel ratio of the internal combustion engine 1-1, that is, the air fuel ratio within the combustion chamber A in each of the cylinders 11 to the lean side with respect to a theoretical air fuel ratio, and lean controls the air fuel ratio (step ST103). The ignition timing control unit 54 sets the ignition timing, for example, as shown in FIG. 3B, such that the ignition plug 14 in each of the cylinders 11 ignites at five degree before a piston top dead center (5BTDC) at a time of setting the target ignition timing to the crank angle at the piston top dead center, and ignites the ignition plug 14.

The fuel supply amount control unit 56 and/or the intake air amount control unit 55 are structured such that, for example, in the case the valve opening degree of the throttle valve 24 by the intake air amount control unit 55 is fixed at a time of starting the internal combustion engine 1-1, the fuel supply amount control unit 56 sets the fuel supply amount at which the air fuel ratio of the internal combustion engine 1-1 comes to the lean side with respect to the theoretical air fuel ratio based on the intake air amount corresponding to the valve opening degree, and injects the fuel at the fuel injection amount based on the set fuel supply amount from the fuel injection valve 31. When the fuel injection amount of the fuel injection valve 31 by the fuel supply amount control unit 56 is fixed at a time of starting the internal combustion engine 1-1, the intake air amount control unit 55 sets the intake air amount at which the air fuel ratio of the internal combustion engine 1-1 comes to the lean side with respect to the theoretical air fuel ratio based on the fuel supply amount corresponding to the fuel injection amount, and changes the throttle valve 24 to the valve opening degree based on the intake air amount.

Accordingly, the air fuel ratio of the internal combustion engine 1-1 is always set to the lean side by the air fuel ratio control unit until the ignition timing mentioned below reaches the target ignition timing, that is, until the start of the internal combustion engine 1-1 is finished after the cranking. Accordingly, in comparison with the case where the air fuel ratio of the internal combustion engine 1-1 is set to the theoretical air fuel ratio by the air fuel ratio control unit, it is possible to increase an amount of the oxygen contained in the exhaust gas exhausted to the exhaust path 40 from each of the combustion chambers A. Accordingly, the purifying apparatus 41 of the exhaust path 40 can further oxidize the HC contained in the exhaust gas by the purifying catalyst (not shown), can reduce the amount of the HC exhausted to the atmosphere from the exhaust path 40, and can suppress the deterioration of the emission.

Next, the ignition timing control unit 54 of the processing unit 52 acquires the engine speed as shown in FIG. 2 (step ST104). In other words, it acquires the engine speed that is detected by the angle sensor 71 and is output to the ECU 50. In this case, the engine speed of the internal combustion engine 1-1 which is set fixed based on the cranking ascends according to the explosive combustion of the mixed gas within the combustion chamber A in any one cylinder 11 in the cylinders 11 of the internal combustion engine 1-1. Accordingly, the engine speed is acquired after the cranking of the internal combustion engine 1-1 due to the ascent of the engine speed, that is, for judging that the crank shaft of the internal combustion engine 1-1 is rotated by the rotating force applied by the explosive combustion of the mixed gas.

Next, the ignition timing control unit 54 of the processing unit 52 judges whether or not the first cycle after the cranking is finished per the cylinder (step ST105). In other words, it judges whether or not the mixed gas within the combustion chamber A is first exploded and burned in the cranking state per the cylinder. For example, as mentioned above, since the engine speed ascends higher than the fixed engine speed by the cranking based on the explosive combustion of the mixed gas within the combustion chamber A from the cranking state, it is possible to judge whether or not the acquired engine speed is equal to or more than the predetermined engine speed.

As shown in FIG. 3B, since the ignition timing control unit 54 has already set the ignition timing to the spark advance side at the first cycle of the cylinder 11, the engine speed just after the cranking widely ascends in comparison with the case where the ignition timing is controlled to the spark retard side just after the cranking such as the convention control apparatus of the internal combustion engine (A (a one-dot chain line) in FIG. 3A). In this case, for example, the engine speed in the case where the ignition timing in each of the cylinders 11 is set to the spark retard side with respect to the target ignition timing after each of the cylinders 11 finishes the first cycle, that is, after a predetermined cycle and is maintained (L (a dotted line) in FIG. 3B) descends according to an increase of the cycle number in each of the cylinders 11 of the internal combustion engine 1-1 (K (a dotted line) in FIG. 3A), however, the engine speed at a time when the descent of the engine speed is started becomes higher in comparison with the conventional internal combustion engine (A (the one-dot chain line) in FIG. 3A). In other words, it is possible to increase the cycle number required until the engine speed comes to the engine speed by which the rotation of the crank shaft 70 can not be maintained by the rotating force applied to the crank shaft 70 in each of the cylinders 11, after the cranking. Therefore, since it is possible to elongate a period in which the rotation of the crank shaft 70 can be maintained by the rotating force applied to the crank shaft 70 in each of the cylinders 11, it is possible to inhibit the startability of the internal combustion engine 1-1 from being lowered.

Further, the combustion temperature of the combustion gas within the combustion chamber A in each of the cylinders 11 is low in the first cycle after the cranking, and the amount of the HC contained in the exhaust gas exhausted to the exhaust path 40 is hardly changed even if the ignition timing in the first cycle is changed. Accordingly, in the first cycle after the cranking, even if the ignition timing is set to the spark advance side with respect to the target ignition timing, the amount of the HC exhausted to the atmosphere from the exhaust path 40 is never increased. Therefore, it is possible to suppress the deterioration of the emission.

Next, if the ignition timing control unit 54 of the processing unit 52 judges that the first cycle is finished, as shown in FIG. 2, it sets the ignition timing to the spark retard side with respect to the target ignition timing (step ST106). For example, as shown in FIG. 3B, when the target ignition timing control unit 54 sets the target ignition timing to the crank angle at the piston top dead center, it sets the ignition timing such that each of the ignition plugs 14 ignites 15 degree after the piston top dead center (15 ATDC) in the first cycle in each of the cylinders 11, and ignites the ignition plug 14. In other words, it sets the ignition timing after the second cycle corresponding to the timing after the predetermined cycle to the spark retard side with respect to the target ignition timing, and executes the spark retard control of the ignition timing.

In this case, for example, the exhaust temperature of the exhaust gas exhausted to the exhaust path 40 in the case where the ignition timing after the second cycle is set to the spark retard side with respect to the target ignition timing so as to be maintained fixed (L (the dotted line) in FIG. 3B) can widely ascend in comparison with the case where the cycle number of the cylinder 11 makes progress at a time when the ignition timing is the target ignition timing (M (a dotted line) in FIG. 3C) if the cycle number of the cylinder 11 makes progress such as the second cycle, the third cycle, the fourth cycle, . . . , as shown in FIG. 4. In other words, the exhaust temperature can ascend in an early timing after the cranking if the ignition timing is in the spark retard side with respect to the target ignition timing. Accordingly, it is possible to activate the purifying catalyst (not shown) of the purifying apparatus in the exhaust path 40 in an early timing after the cranking. Therefore, it is possible to reduce the amount of the HC exhausted to the atmosphere from the exhaust path 40 based on an activation of the purifying catalyst, that is, an ascent of the processing capacity of the purifying apparatus 40, and it is possible to suppress the deterioration of the emission.

Next, the ignition timing control unit 54 of the processing unit 52 judges whether or not the set ignition timing reaches the target ignition timing (step ST107), as shown in FIG. 2. In other words, it judges whether or not the ignition timing corrected to the spark advance side reaches the target ignition timing, based on a spark advance correction of the ignition timing mentioned below. When the first cycle of the cylinder 11 is finished, the exhaust gas is exhausted to the exhaust path 40. Accordingly, the fuel supply amount control unit 56 and/or the intake air amount control unit 55 corresponding to the air fuel ratio control unit may set the fuel supply amount and/or the intake air amount based on the air fuel ratio of the exhaust gas detected by the A/F sensor 43, such that the air fuel ratio of the internal combustion engine 1-1 comes to the lean side with respect to the theoretical air fuel ratio.

Next, if the ignition timing control unit 54 of the processing unit 52 judges that the set ignition timing does not reach the target ignition timing, it acquires the exhaust temperature of the exhaust gas (step ST108). In particular, it acquires the exhaust temperature of the exhaust gas detected by the exhaust temperature sensor 44.

Next, the ignition timing control unit 54 of the processing unit 52 calculates the spark advance correction amount in correspondence to the acquired exhaust temperature (step ST109). In this case, the spark advance correction amount is calculated in such a manner that the oxidation of the HC contained in the exhaust gas by the purifying catalyst is promoted in correspondence to the acquired exhaust temperature at a time when the ignition plug ignites at the ignition timing corrected in the spark advance direction based on the spark advance correction amount. For example, the ignition timing map based on the exhaust temperature and the ignition timing is previously stored in the memory unit 53. In the ignition timing map, there is set an HC oxidation promoting region which can promote the oxidation of the HC contained in the exhaust gas, as shown in FIG. 4. The ignition timing processing unit 54 acquires the ignition timing map, and calculates the spark advance correction amount at which the ignition timing corrected by the spark advance correction enters into the HC oxidation promoting region, based on the ignition timing map and the acquired exhaust temperature. In this case, since the HC oxidation promoting region of the ignition timing map is expanded by controlling the air fuel ratio of the internal combustion engine 1-1 to the lean side, it is possible to increase the spark advance correction amount, and it is possible to further correct the ignition timing in the spark advance direction. Accordingly, it is possible to further suppress the reduction of the engine speed in connection with the increase of the cycle number after the predetermined cycle, and it is possible to further suppress the reduction of the startability of the internal combustion engine 1-1. In this case, the HC oxidation promoting region of the ignition timing map is changed by a cooling water temperature of the internal combustion engine 1-1. Therefore, the cooling water temperature may be acquired together with the exhaust temperature, and the spark advance correction amount may be calculated based on the acquired exhaust temperature, cooling water temperature and ignition timing map.

Next, the ignition timing control unit 54 of the processing unit 52 corrects the ignition timing to the spark advance direction based on the calculated spark advance correction amount, and executes the spark advance correction control of the ignition timing, as shown in FIG. 2 (step ST110). Further, the ignition timing control unit 54 judges whether or not the spark advance corrected ignition timing reaches the target ignition timing (step ST107). If the ignition timing control unit 54 of the processing unit 52 judges that the spark advance corrected ignition timing does not reach the target ignition timing, it again acquires the exhaust temperature (step ST108), calculates the spark advance correction amount in correspondence to the acquired exhaust temperature (step ST109), corrects the ignition timing to the spark advance direction based on the calculated spark advance correction amount (step ST110), and repeats the above operations (the step ST108 to the step ST110) until the spark advance corrected ignition timing comes to the target ignition timing, and the operation of the internal combustion engine 1-1 according to the first embodiment is finished. In other words, it repeatedly spark advance corrects the ignition timing set to the spark retard side of the target ignition timing until it reaches the target ignition timing.

As mentioned above, the control apparatus of the internal combustion engine 1-1 according to the first embodiment repeatedly executes the spark advance correction until the ignition timing comes to the target ignition timing after setting the ignition timing after the second cycle corresponding to the timing after the predetermined cycle to the phase delay side with respect to the target ignition timing (C (a solid line in FIG. 3B). In this case, if the ignition timing is spark advance corrected, an ascending width of the exhaust temperature ascending in connection with the increase of the cycle number is lowered in comparison with the case where the ignition timing after the second cycle is set to the phase delay side with respect to the target ignition timing so as to be maintained fixed (M (a dotted line in FIG. 3C), however, the ascent of the exhaust temperature in connection with the increase of the cycle number after the predetermined cycle is maintained. The ignition timing is corrected to the spark advance direction in such a manner that the oxidation of the HC contained in the exhaust gas is promoted in correspondence to the acquired exhaust temperature while maintaining the ascent of the exhaust temperature. Accordingly, since the ignition timing comes close to the target ignition timing in connection with the increase of the cycle number after the predetermined cycle, it is possible to suppress the reduction of the engine speed in connection with the increase of the cycle number after the predetermined cycle while maintaining the activation of the purifying apparatus (B (a solid line) in FIG. 3A). Accordingly, it is possible to suppress the reduction of the startability as well as it is possible to suppress the deterioration of the emission.

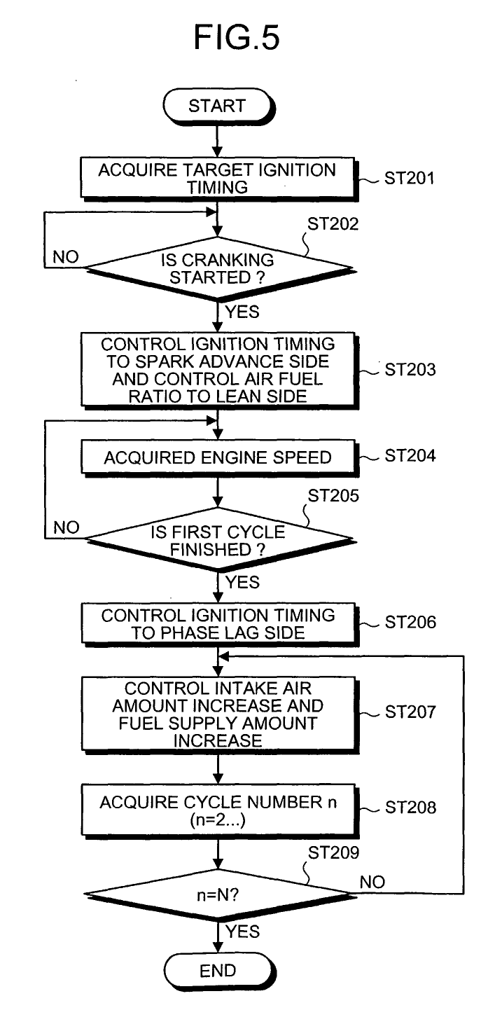

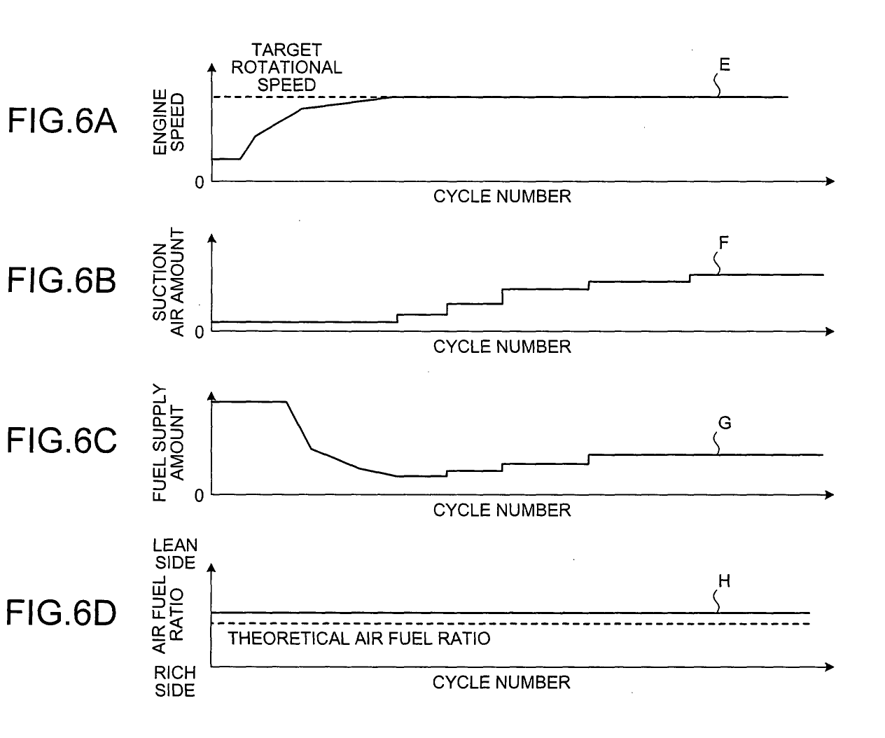

FIG. 5 is a flowchart showing an operation flow of a control apparatus of an internal combustion engine according to a second embodiment. FIG. 6A is a graph showing a relation between cycle number and engine speed; FIG. 6B is a graph showing a relation between cycle number and intake air amount; FIG. 6C is a graph showing a relation between cycle number and fuel supply amount; and FIG. 6D is a graph showing a relation between cycle number and air fuel ratio. A basic structure of an internal combustion engine 1-2 according to the second embodiment is the same as that of the internal combustion engine 1-1 according to the first embodiment, as shown in FIG. 1. In this case, as mentioned above, since the basic structure of the internal combustion engine 1-1 according to the second embodiment is the same as that of the internal combustion engine 1-1 shown in FIG. 1, the description thereof will be not repeated.

Next, an operation of the control apparatus of the internal combustion engine 1-2 according to the second embodiment will be described. In this case, since a basic operation of the control apparatus of the internal combustion engine 1-2 according to the second embodiment is approximately the same as the basic operation of the ECU 50 corresponding to the control apparatus of the internal combustion engine 1-1 according to the first embodiment shown in FIG. 2, the basic operation is briefly described.

First, as shown in FIG. 5, the ignition timing control unit 54 of the processing unit 52 of the ECU 50 acquires a target ignition timing at a time of starting the internal combustion engine 1-1 (step ST201). Next, the ignition timing control unit 54 judges whether or not the cranking is started (step ST202). In this case, the ignition timing control unit 54 of the processing unit 52 repeats the step ST202 if it judges that the cranking is not started.

Next, if the ignition timing control unit 54 of the processing unit 52 judges that the cranking is started, it sets the ignition timing to the spark advance side with respect to the target ignition timing, and executes the spark advance control of the ignition plug. Further, if the ignition timing control unit 54 judges that the cranking is started, the fuel supply amount control unit 56 and the intake air amount control unit 55 of the processing unit 52 corresponding to the air fuel ratio control unit set the air fuel ratio of the internal combustion engine 1-1, that is, the air fuel ratio within the combustion chamber A in each of the cylinders 11 to the lean side with respect to a theoretical air fuel ratio, and lean controls the air fuel ratio (step ST203).

Next, the ignition timing control unit 54 of the processing unit 52 acquires the engine speed (step ST204). Next, the ignition timing control unit 54 judges whether or not the first cycle after the cranking is finished per the cylinder (step ST205). Next, if the ignition timing control unit 54 judges that the first cycle is finished, as shown in FIG. 2, it sets the ignition timing to the spark retard side with respect to the target ignition timing (step ST206).

Next, the fuel supply amount control unit 56 and the intake air amount control unit 55 of the processing unit 52 corresponding to the air fuel ratio control unit execute the control of the intake air amount increase and the fuel supply amount increase while the air fuel ratio 1-1 of the internal combustion engine is maintained fixed (step ST207). The fuel supply amount control unit 56 and the intake air amount control unit 55, for example, set to increase the intake air amount and the fuel supply amount (F and G (solid lines) in FIGS. 6B and 6C) while maintaining the air fuel ratio of the internal combustion engine 1-1 in an optional air fuel ratio (H (a solid line) in FIG. 6D) in the lean side with respect to the theoretical air fuel ratio, and injects the fuel injection amount based on the set fuel supply amount from the fuel injection valve 31 as well as the throttle valve 24 is changed to a valve opening degree based on the set intake air amount.

Next, the ignition timing control unit 54 of the processing unit 52 acquires a cycle number n as shown in FIG. 5 (step ST208). In other words, it acquires the cycle number of the cylinder 11 detected by the angle sensor 71 and is output to the ECU 50. Next, the ignition timing control unit 54 judges whether or not the acquired cycle number n comes to a target cycle number N (step ST209). The target cycle number N corresponds to a cycle number which can maintain the rotation of the crank shaft 70 based on the rotating force applied to the crank shaft 70 in each of the cylinders 11 even if the start of the internal combustion engine 1-1 is finished, that is, the ignition timing is set to the target ignition timing.

Next, the ignition timing control unit 54 of the processing unit 52 judges that the acquired cycle number n does not come to the target cycle number N, it again executes the control of the intake air amount increase and the fuel supply amount increase (step ST207), and repeats the above operations (the step ST207 and the step ST208) until the acquired cycle number n comes to the target cycle number N and the operation of the internal combustion engine 1-2 according to the second embodiment is finished. In other words, it continues to set to increase the intake air amount and the fuel supply amount while maintaining the air fuel ratio of the internal combustion engine 1-1 in the optional air fuel ratio in the lean side (H (a solid line) in FIG. 6D), and continues to control the intake air amount increase and the fuel supply amount increase, until the acquired cycle number n comes to the target cycle number N.

As mentioned above, the control apparatus of the internal combustion engine 1-2 according to the second embodiment increases the intake air amount and the fuel injection amount during a period when the ignition timing is set to the spark retard side from the target ignition timing, that is, from the second cycle to the target cycle (F and G (solid lines in FIGS. 6B and 6C). Accordingly, it is possible to increase the rotating force applied to the crank shaft 70 in each of the cylinders 11 in comparison with the case where the ignition timing after the second cycle is set to the phase delay side with respect to the target ignition timing. Therefore, it is possible to suppress the reduction of the engine speed in connection with the increase of the cycle number after the predetermined cycle (E (a solid line in FIG. 6A). Accordingly, it is possible to suppress the reduction of the startability as well as it is possible to suppress the deterioration of the emission, in the same manner as the control apparatus of the internal combustion engine 1-1 according to the first embodiment.

In this case, in the second embodiment, the throttle valve 24 executes the increase of the intake air amount, however, the structure is not limited to this. For example, the structure may be made such as to add intake air valve lift amount variable unit which can change a lift amount of the intake air valve 15a, that is, can increase the intake air amount, to the valve apparatus 15, and the increase of the intake air amount until the ignition timing is set to the spark retard side from the target ignition timing may be executed by the intake air valve 15a.

Further, in the case where the target engine speed at a time of starting the internal combustion engine 1-2 is set, and the engine speed reaches the target rotational speed based on the control of the intake air amount increase and the fuel supply amount increase, the intake air amount increase and the fuel supply amount increase may be stopped, or the current intake air amount and the current fuel supply amount may be maintained.

Further, in the second embodiment, the ignition timing is set to the spark retard side from the target ignition timing so as to be maintained fixed, until the cycle number comes to the target cycle number after the predetermined cycle, however, the structure is not limited to this. For example, in the same manner as the first embodiment, the structure may be made such that the exhaust temperature is acquired, and the ignition timing is spark advance corrected based on the exhaust temperature.

Further, in the first and second embodiments, it is sufficient that the air fuel ratio of the internal combustion engines 1-1 and 1-2 is set to the lean side with respect to the theoretical air fuel ratio until the ignition timing reaches the target ignition timing after the cranking, or until the cycle number comes to the target cycle number after the cranking. Accordingly, the air fuel ratio of the internal combustion engines 1-1 and 1-2 may be changed until the ignition timing reaches the target ignition timing after the cranking, or until the cycle number comes to the target cycle number after the cranking.

Further, in the first and second embodiments, the predetermined cycle is set to the first cycle just after the cranking, however, the structure is not limited to this. Taking into consideration the allowable amount of the HC contained in the exhaust gas exhausted to the exhaust path 40, the predetermined cycle may be set to the timing after the second cycle after the cranking. In this case, since the combustion temperature of the combustion gas within the combustion chamber A in each of the cylinders 11 ascends step by step after the second cycle, and affects the change of the amount of the HC contained in the exhaust gas exhausted to the exhaust path 40 by changing the ignition timing, it is preferable that the predetermined cycle is set to a tenth cycle after the cranking.

### INDUSTRIAL APPLICABILITY

As mentioned above, the control apparatus and the control method of the internal combustion engine according to the invention are useful for the control apparatus and the control method of the internal combustion engine having the ignition timing control unit controlling the ignition timing of the ignition unit at a time of starting the internal combustion engine by the starting unit, and can particularly suppress the reduction of the startability as well as can suppress the deterioration of the emission.

1. A control apparatus of an internal combustion engine, the control apparatus comprising an ignition timing control unit controlling an ignition timing of an ignition unit at a time of starting the internal combustion engine by a starting unit,
wherein the ignition timing is set to a spark advance side with respect to a target ignition timing at a time of starting the internal combustion engine until a predetermined cycle after a cranking by the starting unit, the time of starting the internal combustion engine until the predetermined cycle after the cranking by the starting unit being before a state of explosive combustion is reached, and is set to a spark retard side with respect to the target ignition timing after the predetermined cycle.

2. The control apparatus of an internal combustion engine according to claim 1,
wherein the ignition timing set to the spark retard side of the target ignition timing is corrected to the spark advance side repeatedly until the ignition timing comes to the target ignition timing.

3. The control apparatus of an internal combustion engine according to claim 2, further comprising an exhaust temperature detecting unit detecting an exhaust temperature of exhaust gas exhausted from the internal combustion engine,
wherein the spark advance correction is set to an ignition timing at which oxidation of hydrocarbon contained in the exhaust gas is promoted in correspondence to the detected exhaust temperature.

4. The control apparatus of an internal combustion engine according to claim 1, further comprising an air fuel ratio control unit controlling an air fuel ratio of the internal combustion engine at a time of starting the internal combustion engine by the starting unit,
wherein the air fuel ratio is set to a lean side until the start of the internal combustion engine is finished after the cranking by the starting unit.

5. The control apparatus of an internal combustion engine according to claim 1,
wherein the predetermined cycle corresponds to the first cycle after the cranking by the starting unit.

6. The control apparatus of an internal combustion engine according to claim 1, further comprising:
a fuel supply amount control unit controlling a supply amount of a fuel supplied to the internal combustion engine; and
an intake air amount control unit controlling an amount of intake air sucked to the internal combustion engine,
wherein the intake air amount and the fuel injection amount are increased at least during a period when the ignition timing is set to the spark retard side from the target ignition timing.

7. A control method of an internal combustion engine controlling an ignition timing of an ignition unit at a time of starting the internal combustion engine by a starting unit, the method comprising:
setting an ignition timing to a spark advance side with respect to a target ignition timing at a time of starting the internal combustion engine until a predetermined cycle after a cranking by the starting unit, the time of starting the internal combustion engine until the predetermined cycle after the cranking by the starting unit being before a state of explosive combustion is reached; and
setting the ignition timing to a spark retard side with respect to the target ignition timing after the predetermined cycle.
